(19) United States
(12) Patent Application Publication
(10) Pub. No.: US 2019/0136979 A1
(43) Pub. Date: May 9, 2019

(54) SUPPORT STRIP WITH REINFORCING MEANS

(71) Applicant: LWB STEINL GMBH & CO. KG, Altdorf (DE)

(72) Inventors: Hanno Gellrich, Garching (DE); Christian Nutz, Ergoldsbach (DE)

(73) Assignee: LWB STEINL GMBH & CO. KG, Altdorf (DE)

(21) Appl. No.: 16/096,036

(22) PCT Filed: Apr. 26, 2017
(86) PCT No.: PCT/EP2017/059988

§ 371 Date: Oct. 24, 2018

(30) Foreign Application Priority Data
Apr. 27, 2016 (DE) 10 2016 005 074.8

(51) Int. Cl. F16J 15/12

(52) U.S. Cl. CPC F16J 15/121; B60J 10/18

(57) ABSTRACT

The invention relates to a deformable support strip as an insert for decorative or sealing strips made of a flexible material, in particular for rubber and/or plastic clamping profiles, comprising a metal strip which comprises a first strip portion and a second strip portion which are interconnected at a connecting point, the support strip being provided to increase the stability in the region of the connecting point with reinforcing means.

The present invention relates to a deformable support strip used as an insert for decorative or sealing strips made of a flexible material, in particular for rubber and/or plastic clamping profiles. The present invention relates to an improvement of the support strip and a method for manufacturing a support strip of this kind.

Support strips which are used as reinforcing insert for decorative or sealing strips made of rubber or plastic are known, for example, from DE 10 2010 019 458 A1. Support strips of this kind normally comprise a metal strip having slots formed in the metal strip by punching or cutting and subsequently stretching.

The support strips are often wound as so-called endless strips on spools having a winding length of several kilometers. For preparing these endless strips, a plurality of individual strip portions can be connected to each other, in particular in that the ends of the strip portions are welded together at a connecting point. This is normally done before the slots are made, partly also afterwards. Partly also full strips (solid strips, i.e. strips without slots) are processed.

In subsequent manufacturing steps, the support strips can be bent to form a profile and can be coated with plastic and/or with rubber in an extrusion process.

In connection with the further processing of the support strips it turned out that the latter tear sometimes, which might lead to considerable machine dead times.

Therefore, it is the object of the present invention to provide a support strip as an insert for decorative or sealing strips made of a flexible material, in particular for rubber and/or plastic clamping profiles, wherein said support strip can be further processed in an improved manner.

This object is achieved with the features of the independent claims. The dependent claims are directed to further aspects of the invention.

The inventors found out that the connecting point or connecting portion has a considerable influence on the support strip's susceptibility to tearing, in particular in case the connecting point is formed as a welding point or welding position. In tensile tests it was found out that strip parts of the support strip in the region of a connecting point may possibly have a clearly lower tensile strength than strip parts away from such a connecting point.

Based on this finding, according to a first aspect, the invention relates to a deformable support strip as an insert for decorative or sealing strips made of a flexible material, in particular for rubber and/or plastic clamping profiles, wherein the support strip preferably comprises a metal strip having a first strip portion and a second strip portion being connected to each other at a connecting point. For increasing the stability in the region of the connecting point, in particular the tensile strength, the support strip moreover comprises a reinforcing means, element or substance. The reinforcing means is preferably not provided along the entire support strip but in sections in the region of the connecting point(s) and/or other weak points of the strip. Since the inventors found out that tearing normally takes place in the region of the heat influence zone around the weld, it is preferred that the reinforcing means extends at most 20%, at most 50% or at most 100% longer than the heat influence zone in the longitudinal direction of the strip. For example, the reinforcing means can be selected such that it extends at most 20 mm, at most 15 mm or at most 10 mm in the longitudinal direction of the strip. It can extend at least 5 mm or at least 10 mm in the longitudinal direction of the strip. The connecting point or connecting points can be in particular welding points.

The support strip according to the invention can preferably be a semi-finished product for manufacturing decorative or sealing strips or profile strips. The support strip can provide for a clamping force of the decorative or sealing strips or profile strips.

Several metal strip portions can be connected to each other in that the ends of the strip portions are welded together. The metal strip is further processed to a support strip which preferably comprises a plurality of central slots arranged transversely with respect to the longitudinal direction of the support strip and/or a plurality of edge slots directed inwardly from both edges transversely with respect to the longitudinal direction of the support strip. These slots are preferably made in a roll cutting process. For this purpose, first of all a pattern of thin cuts is made by means of a tool, wherein the slots are formed by subsequently stretching the strip. However, the slots can also be made in a different process, for example in a punching process.

The reinforcing means is preferably introduced in at least one of the slots and/or it extends preferably across at least one of the slots. The reinforcing means is therefore preferably provided to the metal strip only after making the slots, i.e. preferably not already directly after connecting the first and the second strip portions. Preferably, the reinforcing means is applied to the metal strip and/or introduced in the slot or slots after making the slots. In full strips (i.e. solid strips), the reinforcing means can be applied to the connecting point and extend, for example, across the welding point.

The metal strip is preferably made of an aluminum alloy or steel. The reinforcement according to the invention turned out to be particularly advantageous in particular in aluminum strips, because in these strips a particularly good improvement of the reduced tensile strength could be achieved in the region of the welding point. The reinforcing means is preferably made of one or more materials differing from the material of the metal strip.

The first strip portion and the second strip portion are preferably connected by means of a weld, for example a TIG weld. Possibly, however, also other connection techniques can be used, for example point welding. Point welding is particularly suitable when strip portions are to be connected at a later time point of the manufacturing process (in particular after making the slots).

The weld can extend in an inclined manner relative to the longitudinal direction of the support strip, for example at an angle of 90° to 60°, 90° to 70°, 90° to 80°, 90° to 85°, 85° to 65° or 70° to 80° (e.g. about 90° or about 75°) relative to the longitudinal direction.

The reinforcing means of the support strip according to the present invention is preferably configured such that the tensile strength in the region of the welding point is approximately the same as the tensile strength of a non-welded region of the support strip. The tensile strength in the region of the reinforced welding point, however, can also differ from the tensile strength of the non-welded region of the support strip and can be, for example, at most 20%, at most 10%, at most 5% or at most 2% smaller than the tensile strength of the non-welded region of the support strip. The tensile strength can even be higher than that in the non-welded region of the support strip. The tensile strength of the support strip in the region of the welding point and the tensile strength of the non-welded region of the metal strip region can preferably be determined by a respective tensile test with a piece of a support or metal strip of 500 mm length at a constant movement speed of 100 mm/min. The tensile test can be performed in accordance with DIN EN 10002-1. For evaluation, the force-displacement characteristic can be recorded and the achieved maximum force of the tensile specimen can be considered to be its tensile strength.

In other words, the reinforcing means preferably compensates for the weakening of the metal strip in the region of the welding point (which can be up to approx. 30% in accordance with the findings of the inventors) at least partly or even completely. For example, the reinforcing means in particular can be configured such that the tensile strength of a support strip part with a welding point being reinforced by means of the reinforcing means is increased relative to the tensile strength of a support strip part with an accordingly non-reinforced welding point (in both cases measured with a strip part having a length of 500 mm and at a movement speed of 100 mm/min) by at least 20%, at least 30% or at least 40%.

For allowing a particularly good further processability of the support strip, the reinforcing means is preferably configured such that the thickness of the support strip in the region of the reinforcing means is not increased considerably. In particular, the reinforcing means can be configured such that the thickness of the support strip in this region is at most 25%, at most 20%, at most 15% or at most 10% larger than the thickness of the remaining support strip or than the thickness of the metal strip itself.

For this purpose, the reinforcing means can, for example, comprise a film applied to the support strip and/or can be formed by such a film. The films are considered to be one-layered or multi-layered films or laminates. They are preferably made of plastic materials and can optionally be transparent. Also films and/or foils with or made of metallic materials can possibly be used. For example, a PET film which can be applied, e.g., as a composite with a polyurethane heat seal film as adhesive is suitable.

The film is preferably at most 0.2 mm, at most 0.15 mm, at most 0.1 mm, at most 0.08 mm, at most 0.05 mm, or at most 0.025 mm thick. For example, a PET film having a thickness of 5 to 20 μm or 10 to 15 μm can be used.

The film is preferably configured such that it can be adhered to at least one side of the metal strip in the region of the weld. In order to avoid contamination during further manufacturing steps, the film preferably comprises an activatable adhesive. For example, it can be a heat-activatable film. Also UV curing and/or a chemical activation is/are possible.

The film can be applied to one side or both sides of the metal strip. An application of the film to one side can be realized particularly advantageously in terms of manufacturing. An application of the film to one side already leads to a sufficient increase in the tensile strength in many applications. Preferably, the reinforcing means is applied to the side of the support strip that forms the inner side of the profile when the support strip is further processed to a profile.

Preferably, a first portion of the film is applied to the first strip portion. A second portion of the film is preferably applied to the second strip portion. Preferably, the film extends at least partly across the welding point, in particular at least partly across the weld. For example, the film can extend across a region having at least one, at least two or at least three slots succeeding each other in the longitudinal direction of the support strip (e.g. succeeding central slots).

The support strip according to the invention preferably can be bent to a U-shaped or V-shaped profile. To this end, for example, a plurality of succeeding profiling sets can be used, in which the support strip is clamped between rolls that face each other and is successively bent. The reinforcing means preferably has a stretchability of at least 5%, at least 10% or even at least 20%. This is advantageous because the support strip is possibly further stretched in such profiling sets.

The reinforcing means can (optionally) be provided mainly or even exclusively in a central region of the support strip. This central region can extend across at least 10%, at least 20%, at least 30% or at least 40% of the width of the support strip, preferably across at most 50%, at most 40% or at most 30% of the width of the support strip. At least one or both edge regions of the support strip can be left free, wherein these edge regions preferably extend inwardly from the respective edge transversely to the longitudinal direction of the support strip, in each case for example across at least 10%, at least 25% or at least 35% of the width of the support strip. It is assumed that such a leaving-free of the edge regions can be advantageous in particular when a film applied to the metal strip is used as reinforcing means. This has in particular the advantage that the reinforcing means is not damaged in case an increased abrasion or even scraping-off occurs in the edge regions of the support strip during bending to a U-shaped or V-shaped profile because of the arrangement of the rolls. However, the reinforcing means can also extend across the entire width of the metal strip or even only in its edge regions, so that perhaps also the central region can be left free.

Alternatively or in addition to the film as reinforcing means, the support strip according to the invention can also comprise an adhesive (for example a curable adhesive) which is introduced in one or more slots of the metal strip in the region of the welding point and fills said slot(s) at least partially. The slotted region is bridged at least partly by the adhesive. For this purpose, preferably at least some or all of the central and edge slots which surround the weld are filled partly or even completely with the adhesive. In particular the central slots can be filled completely.

The adhesive can be cured at least partly or completely. Without making a commitment, preferably an adhesive that cures by means of UV radiation is used. However, basically also two-component adhesives or heat-curable adhesives can be used.

Preferably, an adhesive that has a relatively high viscosity at room temperature is used. The adhesive is preferably introduced into the slots in such a manner that the upper side and/or the lower side of the metal strip remain(s) substantially free of adhesive. Alternatively or additionally, the adhesive can be removed from the upper and/or the lower side of the metal strip after having been introduced into the slots. This is advantageous in that an unintentional contamination of further metal strip regions and/or the machines is prevented.

According to a further aspect, the invention relates to a method for manufacturing a support strip, in particular a reinforced support strip of the kind described above. The method preferably comprises providing a metal strip having a first strip portion and a second strip portion, wherein the strip portions are interconnected at a connecting point, as well as reinforcing the metal strip in the region of the connecting point by a reinforcing means.

The metal strip preferably comprises a plurality of central slots arranged transversely with respect to the longitudinal direction of the support strip and/or a plurality of edge slots directed inwardly from both edges transversely with respect to the longitudinal direction of the metal strip. For this purpose, the method can comprise, for example, a roll cutting and/or punching step. In particular in case the roll cutting process is used, the slots are made preferably before the metal strip is reinforced. The reinforcing means can then be applied to the metal strip and/or inserted into the slots.

For connecting the strip portions, the method according to the invention can moreover comprise a welding step in which the strip portions are interconnected, for example, by means of a weld. The welding step is preferably performed before the slots are made.

Thus, the invention provides for various possibilities of improving the further processability of support strips. In particular, because of the reinforcing means according to the invention it is possible to guarantee a sufficient tensile strength for further processing steps even in case the support strips are very light-weight and/or thin.

Preferred embodiments of the invention will be described below exemplarily with reference to the drawings. The latter are only schematic illustrations which often do not show other (optional) structures in order to clarify specific aspects or, alternatively, consider various optional interrelated aspects in one illustration. In this connection, equal reference signs indicate equivalent, similar, comparable or equal components in the shown embodiments.

The shown embodiments can be changed in various aspects within the scope of protection of the claims. The disclosure of the Figures is not meant to restrict the scope of protection of the claims. It is pointed out that the features of the above-mentioned embodiments can be combined in one single embodiment. Thus, embodiments of the invention can comprise all or only some of the above-mentioned features, depending on the configuration.

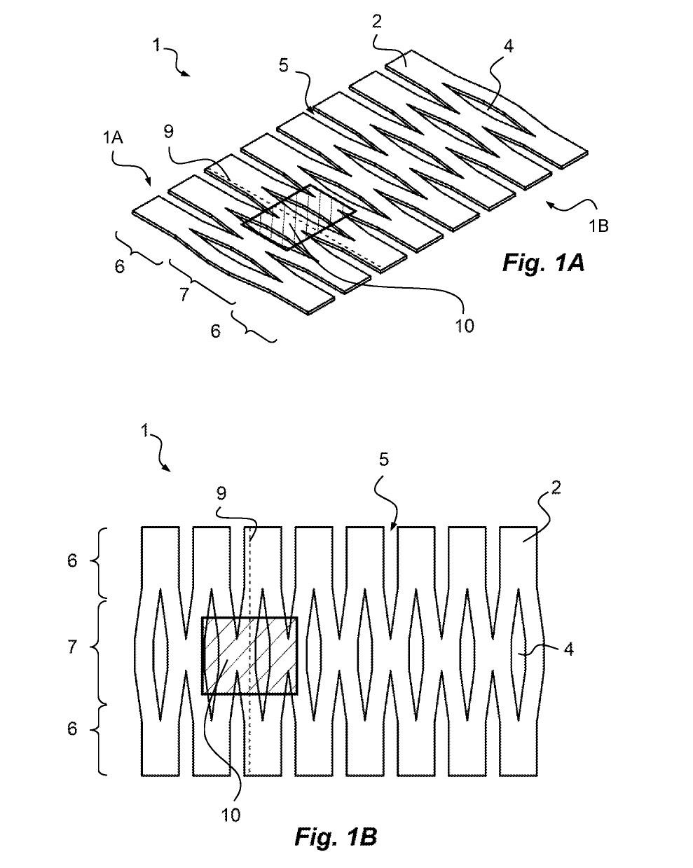

FIG. 1A shows a schematic perspective view of a support strip according to the invention in accordance with a first embodiment;

FIG. 1B shows a schematic top view of the support strip of FIG. 1A;

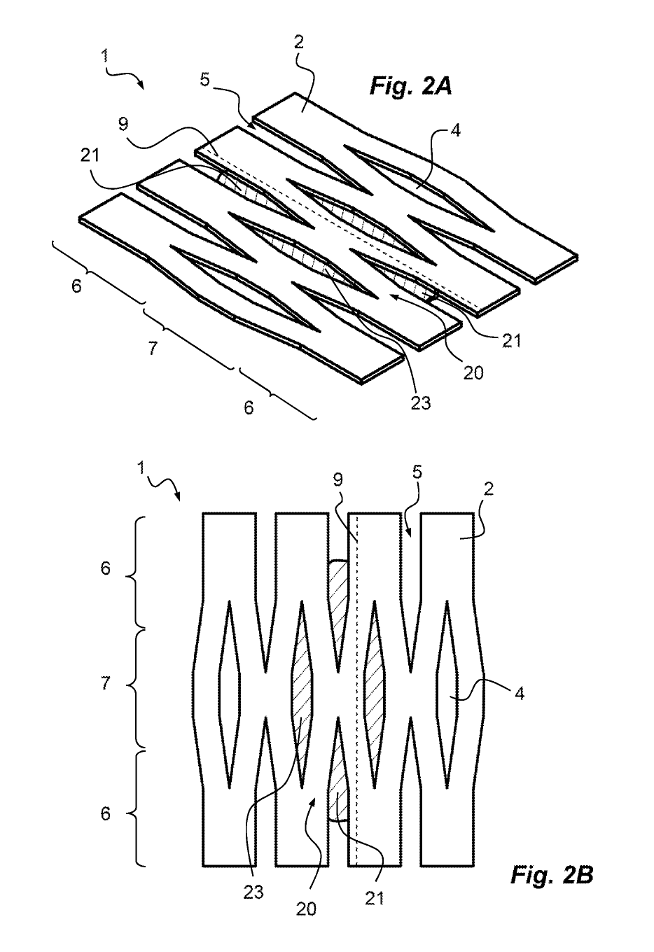

FIG. 2A shows a schematic perspective view of a support strip according to the invention in accordance with a second embodiment;

FIG. 2B shows a schematic top view of the support strip of FIG. 2A.

FIGS. 1A and 1B show a support strip 1 according to a first embodiment. The support strip 1 comprises a first metal strip portion 1A and a second metal strip portion 1B.

The metal strip portions 1A, 1B are connected by a weld 9 indicated as a dashed line and preferably being a TIG weld.

After welding, the metal strip was provided with a plurality of central slots 4 in a central region 7 and a plurality of edge slots 5 in the edge regions 6.

After making the central and edge slots 4, 5, the weld 9 was provided with a film 10 as reinforcing means on the upper side 2 of the support strip 1. The film can be applied to the metal strip by means of a heat-activatable adhesive film and/or a heat-activatable adhesive layer. The film can have, for example, a thickness of 5 to 20 μm or 10 to 15 μm, wherein, however, the film can also be thicker when this is possible in view of the further processing of the support strip. The adhesive film or adhesive layer can comprise a polyurethane adhesive (e.g. a solvent-free polyurethane adhesive), which can be activated at a functional temperature.

At the lower side (which is not visible in the Figures), no film is provided in the shown embodiment. Alternatively, additionally also the lower side is provided with a film 10 of this kind.

In the embodiment of FIGS. 1A and 1B, the film 10 extends across a region having two central slots 4, wherein the film could also extend farther or less in the longitudinal direction of the support strip 1, if required.

The shown film 10 moreover extends in the central region 7, in the shown embodiment without completely covering the central slots 4. However, in view of the disclosure of the present invention, the person skilled in the art will understand that, if required, it is also possible that the film extends farther or less in the transverse direction of the metal strip. In the edge regions 6 no film 10 is provided. This is advantageous in that the risk of peeling-off or partial tearing of the film 10 upon bending of the support strip 1 is reduced. It is optional to leave the edge regions 6 free.

FIGS. 2A and 2B show a support strip 1 according to the invention in accordance with a second embodiment in which the metal strip was reinforced in the region of the weld 9 by introducing and curing an adhesive 20 in the central and edge slots 4, 5, for example by using a UV curing adhesive. The bonding 21 in the edge region 6 fills the edge slots 5 partly and the bonding 23 in the central region 7 fills the central slots 4 completely. In view of the present disclosure, it will be clear to the person skilled in the art that the number of filled slots and/or their degree of filling can be varied depending on the concrete requirements of the individual case.

Before or after curing, the adhesive 20 is preferably removed from the upper side 2 and/or the (non-visible) lower side of the metal strip, or the slots are preferably filled such that the adhesive 20 is not even spread on the upper and lower sides of the metal strip.

The reinforcing means of the embodiments of FIGS. 1A, 1B and 2A, 2B can also be combined, if required, for example in that in the region of the weld 9 first an adhesive 20 is introduced into the central and/or edge slot(s) 4, 5 and the metal strip is subsequently additionally reinforced by applying a film 10.

As far as the above description uses the term “substantially”, also embodiments are comprised in which the respective feature is present entirely or completely. The terms “a plurality” or “several” should be understood in the meaning of “at least two”, i.e. two or more. As far as concrete values are mentioned, they preferably also comprise slight deviations from these values, such as deviations of +/−10% or +/−5% of the respective value. Individual aspects of the invention can also form independent inventions and can also be claimed as such.

1. For use in a decorative or sealing strip made of a flexible material, a deformable support strip comprising:
A. a metal strip comprising
i. a first strip portion, and
ii. a second strip portion connected to the first strip portion at a connecting point;
B. a reinforcing means disposed in a region of the support strip including of the connecting point to provide increased stability to the support strip.

2. The support strip of claim 1, wherein the support strip extends in a longitudinal direction, the support strip having a first edge and a second edge each extending in the longitudinal direction, wherein the metal strip is provided with a plurality of central slots each central slot extending transversely with respect to the longitudinal direction, and a plurality of edge slots each edge slot extending transversely with respect to the longitudinal direction, at least some of the edge slots directed inwardly from the first edge and at least some of the edge slots directed inwardly from the second edge.

3. The support strip of to claim 1, wherein the reinforcing means does not extend across the entire length of the support strip.

4. The support strip of claim 2, wherein the reinforcing means extends across at least one of the central slots or one of the edge slots.

5. The support strip of claim 1, wherein the connecting point is a welding point.

6. The support strip of claim 1, wherein the support strip in the region of the connecting point has a tensile strength that is higher than the tensile strength in a region of the support strip without such a connecting point or is at most 20% lower than the tensile strength in the region of the support strip without such a connecting point.

7. The support strip of claim 1, wherein a thickness of the support strip in the region of the reinforcing means is at most 25% larger than the thickness of a region of the support strip without the reinforcing means.

8. The support strip of claim 1, wherein the reinforcing means comprises a film.

9. The support strip of claim 5, wherein the reinforcing means comprises a film, and wherein the film-(4-0) extends at least partly across the welding point.

10. The support strip of claim 8, wherein the film extends in a central region of the support strip and does not extend in edge regions.

11. The support strip of claim 2, wherein the reinforcing means comprises an at least partly cured adhesive which, at least partly fills at least one of the central slots or at least one of the edge slots.

12. The support strip of claim 11, wherein the adhesive is an adhesive curable by UV radiation.

13. A method for manufacturing a support strip constituting a semi-finished product for manufacturing decorative or sealing strips made of a flexible material, the method comprising the following steps:
providing a metal strip which comprises a first strip portion and a second strip portion which are connected at a connecting point; and
reinforcing the metal strip in atho region of the connecting point by a reinforcing means.

14. The method of claim 13, wherein the metal strip extends in a longitudinal direction, the support strip having a first edge and a second edge each extending in the longitudinal direction, and wherein the metal strip comprises a plurality of central slots, each central slot extending transversely with respect to the longitudinal direction and a plurality of edge slots each edge slot extending transversely with respect to the longitudinal direction, at least some of the edge slots directed inwardly from the first edge and at least some of the edge slots directed inwardly from the second edge.

15. The method of claim 13, wherein the step of reinforcing the metal strip comprises applying the reinforcing means to the metal strip.

16. The support strip according of claim 2, wherein the reinforcing means is disposed in at least one of the central slots or in at least one of the edge slots.

17. The support strip according of claim 8, wherein the film is a heat-activatable film.

18. The support strip according of claim 2, wherein the connecting point is a welding point, wherein the reinforcing means comprises a film extending at least partly across the welding point and across at least one of the plurality of central slots.

19. The support strip according of claim 2, wherein the connecting point is a welding point, wherein the reinforcing means comprises a film extending at least partly across the welding point and across at least two of the plurality of central slots.

20. The method of claim 14, wherein the step of reinforcing the metal strip comprises introducing the reinforcing means into at least one of the central slots or into at least one of the edge slots.
